(19) United States
(12) Patent Application Publication
(10) Pub. No.: US 2022/0180691 A1
(43) Pub. Date: Jun. 9, 2022

(54) GAME TABLE AND PAYOUT SUM CORRECTNESS NOTIFICATION METHOD FOR GAME TABLE

(71) Applicant: SEGA SAMMY CREATION INC., Kanagawa (JP)

(72) Inventors: Makoto Kaneko, Kanagawa (JP); Yuji Shimada, Kanagawa (JP)

(21) Appl. No.: 16/634,572

(22) PCT Filed: Aug. 8, 2019
(86) PCT No.: PCT/JP2019/031513

§ 371 Date: Jan. 27, 2020

(51) Int. Cl. G07F 17/32

(52) U.S. Cl. CPC G07F 17/322; G07F 17/3241; G07F 17/323; G07F 17/3248

(57) ABSTRACT

The present invention provides a game table with which the correctness of a placement sum can be recognized intuitively. The game table includes a reading device for reading a placement sum from information on chips placed in a betting area, a light emitting unit provided in the betting area, and a computer device for managing the progress of a game. The computer device is caused to execute a function for managing the progress of the game, a function for calculating a payout sum corresponding to the outcome of the game, and a function for controlling light emission by the light emitting unit in accordance with the result of a comparison between the payout sum and the placement sum.

### PRIORITY CLAIM

The present application is a national stage application under 35 U.S.C. § 371 of International (PCT) Application No. PCT/JP2019/031513, filed Aug. 8, 2019, which is incorporated herein in its entirety by reference.

### FIELD

The present invention relates to a game table and a payout sum correctness notification method for a game table.

### BACKGROUND

In recent years, game tables using chips on which identification information is electronically recorded have been developed. See Japanese Patent Publication No. JP 2017-211971 A (Patent Document 1), for example. In this game table, for the purpose of fraud prevention, the credit of a user is stored for each user in association with unique identification information, and when a sum indicated by the chip information of a chip located in a predetermined area does not match a sum to be added to or subtracted from the credit stored in association with the identification information, an error is output.

In Patent Document 1, however, whether chips of the correct sum have been paid to the user by a dealer is checked using a card of the user, and therefore the card of the user or other identification means is required.

An inexperienced dealer may make a mistake about the payout sum. Moreover, it is necessary to notify the user of the outcome of the game in an easily understandable manner.

Hence, an object of the present invention is to provide a game table and a payout sum correctness notification method for a game table that overcomes these and other limitations of the prior art.

### SUMMARY

The present application describes a game table and a payout sum correctness notification method for a game table, with which it is possible to recognize intuitively whether or not a payout sum is correct and so on.

A game table according to an aspect of the present invention is a game table having a plurality of betting areas in which to place chips, the game table including a reading device for reading a placement sum from information on the chips placed in the betting areas, a notification unit provided in each of the betting areas, and a computer device for managing the progress of a game, wherein the computer device is caused to execute a function for managing the progress of the game, a function for calculating a payout sum corresponding to the outcome of the game, and a function for executing notification control on the notification unit in accordance with the result of a comparison between the payout sum and the placement sum.

A payout sum correctness notification method for a game table according to an aspect of the present invention is a payout sum correctness notification method for a game table having a plurality of betting areas in which to place chips, the method including the steps of reading a placement amount from information on the chips placed in the betting areas, calculating a payout sum corresponding to the outcome of a game, and executing notification control on a notification unit provided in each of the betting areas in accordance with the result of a comparison between the payout sum and the placement sum.

Advantageous effects of invention may include a notification such as controlling light emission by a light emitting unit provided in each of the betting areas in accordance with the result of comparison between the payout sum and the placement sum issued after chips are placed in the betting areas, thus making it possible to recognize intuitively whether or not the payout sum is correct.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a block diagram showing an example configuration of a management system for a game table according to a first embodiment.

FIG. 2 is a plan view showing an example of an upper surface appearance of the game table according to the first embodiment.

FIG. 3 is an enlarged illustrative view of a playing area of the game table according to the first embodiment.

FIG. 4 is an enlarged illustrative view of a betting area of the game table according to the first embodiment.

FIGS. 5A, 5B, and 5C show illustrative views of examples of winning area displays on the game table according to the first embodiment.

FIGS. 6A, 6B, and 6C show illustrative views of examples of losing area displays on the game table according to the first embodiment.

FIG. 7 is a flowchart showing a payout sum correctness notification method for the game table according to the first embodiment.

### DETAILED DESCRIPTION

A preferred embodiment of the present invention will be described below with reference to the attached figures. In the figures, identical reference symbols have been allocated to identical or similar configurations.

Description of terms: In this specification, terms are defined as follows.
“Game table”: a table on which various types of games are played in a gaming hall. Typically, a single dealer is located at a single table. Further, a plurality of users can participate in a game simultaneously at a single table.
“Dealer”: a person on the gaming hall side who delineates the progress of a game by dealing cards used in the game and so on.
“User”: a guest who visits the gaming hall in order to participate in a game.
“Baccarat”: a traditional card game, in which a user predicts and bets on the outcome of a card game played by a banker (the bookmaker) and a player (the customer). The user simply predicts the outcome of the game, and due to its simplicity, the game is popular in casinos all over the world. The dealer deals two or three cards to each of the banker and the player in accordance with certain rules, and the one to whom cards with a total number of points of which the first digit is closest to “9” are dealt is the winner.
“Blackjack”: a game in which the user aims to acquire a higher number of points from the dealer while ensuring that the total number of points on the cards does not exceed 21.
“Roulette”: a game in which a ball is thrown onto a rotating wheel and the location in which the ball lands is predicted. Bets may be placed on various betting categories, from bets encompassing a plurality of numbers, such as red or black and odd or even, to bets on a specific number.
“Chip”: a virtual currency used by the user to declare a prediction. One “chip” holds credit or points of a fixed sum.
“Bet”: an action performed by the user to declare a prediction and place a bet thereon, and more specifically, an action to place a chip on a betting board. For example, in baccarat, the user bets by predicting that the banker will win, the player will win, or the game will end in a draw (a tie) and placing a bet on the predicted outcome. Further, in blackjack, for example, the user predicts his/her own chance of winning or the like and places a bet in accordance with the predicted outcome. In roulette, the user predicts the location on the roulette wheel in which the ball will land and places a bet on the predicted location.
“Betting area”: an area on the game table where chips are bet. In other words, the area where the user bets chips. For example, in baccarat, betting areas corresponding to a win by the banker, a win by the player, and a tie are indicated on the game table. In roulette, the numbers on the roulette wheel, categories encompassing a plurality of numbers (for example, “RED”, which encompasses the numbers in the red boxes), and so on are indicated on the game table.
“Betting sum”: a sum used when placing a bet. Each user can specify the betting sum as desired by placing chips of the desired type and number in the betting area. When the prediction made by the user is correct, the user acquires a payout corresponding to the betting sum.
“Credit”: the balance held by the user. When the user obtains a payout, the sum of his/her credit increases, and when the prediction made by the user is incorrect, the sum of his/her credit decreases.

### First Embodiment

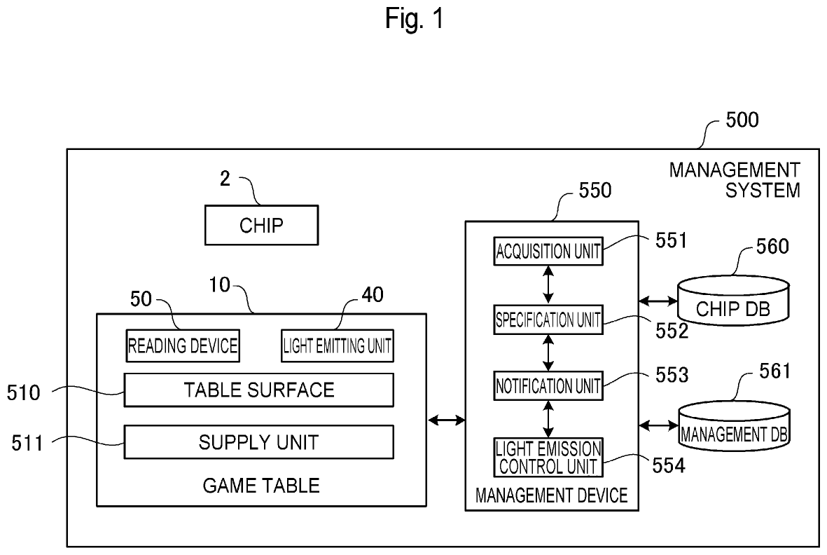

First, referring to FIGS. 1 to 4, configurations of a game table and a management system thereof according to a first embodiment will be described.

Management system configuration: FIG. 1 is a block diagram showing an example configuration of a management system for a game table according to the first embodiment. As shown in FIG. 1, a management system 500 includes a game table 10, chips 2, a management device 550, a management database (DB) 561, and a chip database (DB) 560. Each constituent element will be described specifically below.

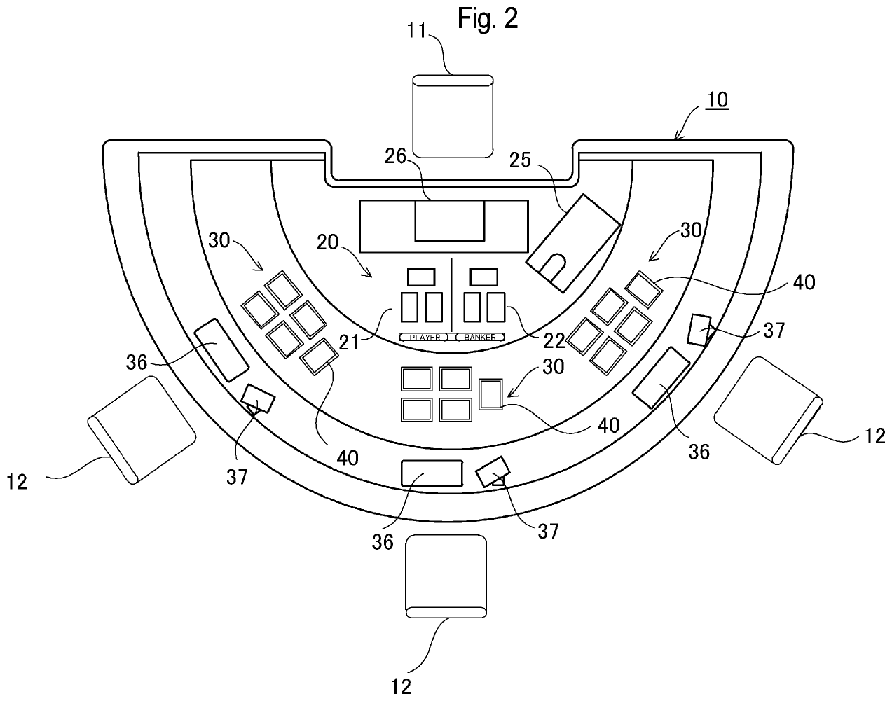

Game table: FIG. 2 is a plan view showing an example of an upper surface appearance of the game table according to the first embodiment. The game table 10 shown in FIG. 2 is an example of a table for playing the traditional card game baccarat. The game table 10 is a semicircular table, for example, including a single playing area 20 and a plurality of betting areas 30 in which users bet (place) chips. The game table 10 includes a light emitting unit 40, a reading device 50 (see FIG. 1), and the management device 550 (see FIG. 1).

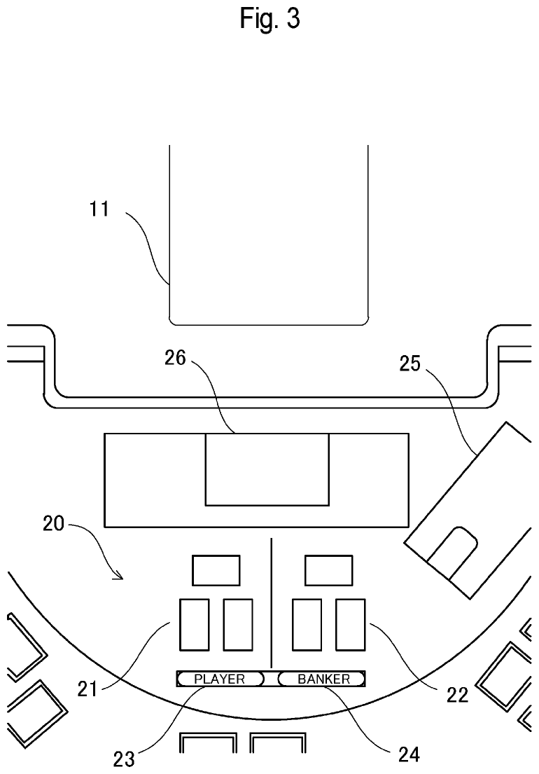

FIG. 3 is an enlarged illustrative view of the playing area of the game table according to the first embodiment. As shown in FIGS. 2 and 3, the playing area 20 is arranged on the game table 10 in front of a dealer seating portion 11. A player area 21 in which to place cards on the player side and a banker area 22 in which to place cards on the banker side are arranged on the left and right sides of the playing area 20. A player side indicator lamp 23 is provided near the player area 21. The player side indicator lamp 23 is illuminated at a timing when cards are to be placed on the player side. A banker side indicator lamp 24 is provided near the banker area 22. The banker side indicator lamp 24 is illuminated at a timing when cards are to be placed on the banker side. Further, a card shoe 25 housing the cards to be dealt is provided near the playing area 20. Furthermore, a payout chip housing portion 26 housing payout chips is provided between the playing area 20 and the dealer seating portion 11.

Referring back to FIG. 2, user seating portions 12 are provided in three locations surrounding the dealer seating portion 11. More specifically, the betting areas 30 according to this embodiment are arranged in three locations on the upper surface of the single game table 10 in accordance with the number of user seating portions 12. In this embodiment, three betting areas 30 are arranged relative to the single game table 10, but the number of betting areas 30 is not limited to three.

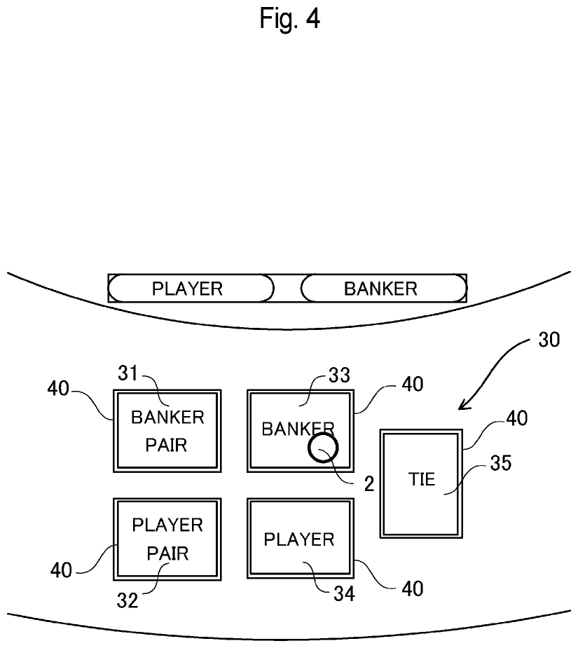

FIG. 4 is an enlarged illustrative view of the betting area of the game table according to the first embodiment. As shown in FIG. 3, a banker pair area 31, a player pair area 32, a banker area 33, a player area 34, and a tie area 35 are arranged in each betting area 30. The banker pair area 31 is an area for betting that a pair will be dealt on the banker side. The player pair area 32 is an area for betting that a pair will be dealt on the player side. The banker area 33 is an area for betting that the banker will win. The player area 34 is an area for betting that the player will win. The tie area 35 is an area for betting on a tie. Area identification information is assigned to each betting area 30 (31, 32, 33, 34, 35).

The light emitting unit 40 is provided in the betting area 30. The light emitting unit 40 is preferably provided in the shape of a frame surrounding each area, namely the banker pair area 31, the player pair area 32, the banker area 33, the player area 34, and the tie area 35. The light emitting unit 40 according to this embodiment is provided in the shape of a frame surrounding each betting area 30, but the light emitting unit 40 may be provided in the vicinity of each betting area 30, and the shape and position of the light emitting unit 40 are not limited. To prevent fraud committed jointly by the user and the dealer, the light emitting unit 40 is preferably installed in a position that can be seen by observers as well as the user and the dealer.

The reading device 50 has a function for electromagnetically reading the identification information of the chips 2 and the area identification information of each betting area 30 in which the chip 2 is placed (see FIG. 1). The reading device 50 is also capable of reading the placement sum of the chips 2 from the identification information of the chips 2. The reading device 50 is also capable of reading betting position information indicating the betting position in which the chip 2 is placed from the identification information of the chip 2 and the area identification information of each betting area 30. Normally, the reading device 50 is provided under the betting area 30 of the game table 10 and is not therefore exposed to the upper surface of the game table 10. A reading device using radio waves, such as RFID, for example, may be used as the reading device 50. A tag provided in the chip 2 is read using a reading device provided on the table side. Further, instead of a reading device using radio waves, a reading device that reads the information on the chip 2 using infrared rays or acoustic waves or the like may be used. Furthermore, the reading device may read data on the chip by reading an image on the chip using a camera.

Referring back to FIG. 2, a display unit 36 for displaying the progress and the result of the game and a card reading unit 37 for reading a user card are provided in each betting area 30 of the game table 10 on the user seating portion 12 side. The user card is a medium storing game information of the user, and points won in previous games, for example, can be stored thereon. The user can receive various services in accordance with the game information stored on the card. Note, however, that the content stored on the card does not affect the result of the game.

Management device: Referring to FIG. 1, the management device 550 includes an acquisition unit 551, a specification unit 552, a notification unit 553, and a light emission control unit 554. The management device 550 reads and writes information from and to the management DB 561 and the chip DB 560.

The management DB 561 is a database server for storing and managing chip owning information (holding information) about the chips owned by the user, the credit information of the user, progress information about various games being played in the gaming hall, and so on. The management device 550, the management DB 561, and the chip DB 560 can each be realized as a computer device (an information processing device).

The previously mentioned computer device may include a control unit (including a central processing unit (CPU) and a memory), a hard disk drive (HDD), and a network interface. Regarding each part of the computer device, the functions of the respective parts of the management device 550 are realized by having the control unit temporarily read a program stored in the HDD to the memory and having the CPU execute the program read to the memory. Further, at least some of the respective parts of the management device 550 may be realized by a plurality of computer devices connected to each other by various types of networks. Furthermore, at least some of the respective parts of the management device 550 may be realized by distributed processing executed by a plurality of computer devices. Moreover, the management device 550 and the management DB 561 are illustrated as separate configurations but may be provided in a single device.

In this embodiment, the single game table 10 is provided in relation to the single management device 550. However, a plurality of game tables 10 may be provided in relation to the single management device 550.

The acquisition unit 551 acquires a result of the processing executed by the management device 550 and information required for the processing. For example, the acquisition unit 551 acquires the position information of the chip 2, which is output from the betting area 30, and the identification information of the chip 2. Further, the acquisition unit 551 is capable of acquiring information such as information indicating the progress of the game being played on the game table 10, information indicating the result of the game, and information indicating the bet placed by the user through the game table 10, the management DB 561, or the like by any desired method.

The specification unit 552 specifies various information calculated on the basis of the information acquired by the acquisition unit 551. For example, the specification unit 552 can specify the position within the betting area 30 in which the chip 2 is placed on the basis of the position information acquired by the acquisition unit 551. The specification unit 552 can specify a position (a betting destination) indicating a section of the betting area 30 on the basis of the area identification information of the betting area 30 and the identification information of the chip 2. Further, the specification unit 552 can specify an allocated sum corresponding to the chip 2 on the basis of the identification information of the chip 2, acquired by the acquisition unit 551. Furthermore, the specification unit 552 can specify the user who owns the chip 2 on the basis of the identification information of the chip 2 by referring the management DB 561.

Using the position information of the chip 2, which is read from the betting area 30, and the identification information of the chip 2 in this manner, the specification unit 552 can specify the user who owns the chip 2, the betting destination of the chip 2, and the betting sum of the chip 2. When a plurality of chips 2 are placed, the betting sum is the sum total thereof. Further, the specification unit 552 can specify a betting period in accordance with the progress of the game. The specification unit 552 has a function for specifying the betting area 30 in which the largest placement sum has been placed within the betting period and a function for causing the light emitting unit 40 of the specified betting area 30 to emit light via the light emission control unit 554. The specification unit 552 also has a function for specifying the result of the game and a payout sum corresponding to the outcome of the game.

The notification unit 553 issues an error notification when the position of the chip 2 cannot be specified by the specification unit 552. Various methods may be used to issue the error notification. For example, the error may take the form of an error message displayed on the display unit 36 provided on the game table 10. The display unit 36 may be provided on the user side, as in this embodiment, or on the dealer side, or so that both the player and the dealer can check the display unit 36. The error display may also take the form of a message indicating that the position of the chip 2 cannot be specified, that a bet has been placed in an invalid position, or the like, for example. Alternatively, a warning lamp, not shown in the figures, provided on the game table 10 may be illuminated, or a voice, a sound effect, or the like may be output from a speaker, not shown in the figures. Alternatively, the table or the chair in which the user is sitting may be caused to vibrate.

In this embodiment, issuing an error notification is useful. When a bet is placed in an ambiguous location, the bet destination intended by the user may differ from the information updated by the management device 550 and the management DB 561. Therefore, by issuing an error notification when the position cannot be specified by the specification unit 552, bets placed in ambiguous locations can be prevented.

The light emission control unit 554 is a control unit for transmitting a control signal (a light emission signal) to the light emitting unit 40 in order to control light emission. The light emission control unit 554 has a function for controlling light emission by the light emitting unit 40 in accordance with the result of a comparison between the payout sum specified by the specification unit 552 and a placement sum placed by the dealer. For example, in a case where the user wins the game, the light emission control unit 554 has a function for causing the light emitting unit 40 to emit light in a first color and a function for causing the light emitting unit 40 to flash when there has been an error in the comparison. Further, in a case where the user wins the game, the light emission control unit 554 has a function for causing the light emitting unit 40 to emit light in the first color and a function for causing the light emitting unit 40 to emit light in a second color when the comparison has been completed successfully. Furthermore, in a case where the user loses the game, the light emission control unit 554 has a function for causing the light emitting unit 40 to emit light in a third color and a function for extinguishing the light emitting unit 40 once the placed chips 2 have been collected. Moreover, in a case where the game ends in a tie, the light emission control unit 554 has a function for causing the light emitting unit 40 to emit light in a fourth color, and a function for extinguishing the light emitting unit 40 once the placed chips 2 have been collected. The light emission control executed on the light emitting unit 40 in accordance with the control signal transmitted by the light emission control unit 554 will be described in detail below.

Further, the chip 2 is provided with a charging function, and a supply unit 511 is provided on the table surface 510 of the game table 10 so that power can be supplied (by wireless power supply, for example) to the chips 2 placed on the table surface 510 from the supply unit 511.

Chip, first database, and second database: Chip identification information is assigned to the chip 2. A correspondence relationship between the chip identification information and the sum allocated to the chip 2 is defined in a first database (the chip DB) 560. The management device 550 has a function for determining the placement sum of the paid-out chips 2 on the basis of the chip identification information of the chips 2 and the sums allocated thereto, which are read by the reading device 50, by referring to the chip DB 560. Further, as described above, area identification information is assigned to the betting area 30. A second database (the management DB) 561 defines a correspondence relationship between the chip identification information assigned to the chips 2 and the area identification information. The management device 550 has a function for determining the validity of the chips 2 placed in the betting area 30 by referring to the management DB 561.

The management device 550 and the game table 10 are connected either wirelessly or by a wire so as to be capable of exchanging information. Note that a relay device such as a router may be provided between the management device 550 and the game table 10. Further, the management device 550 may be provided in the gaming hall or externally. Furthermore, the game table 10 and the management device 550 may be connected by an Internet connection.

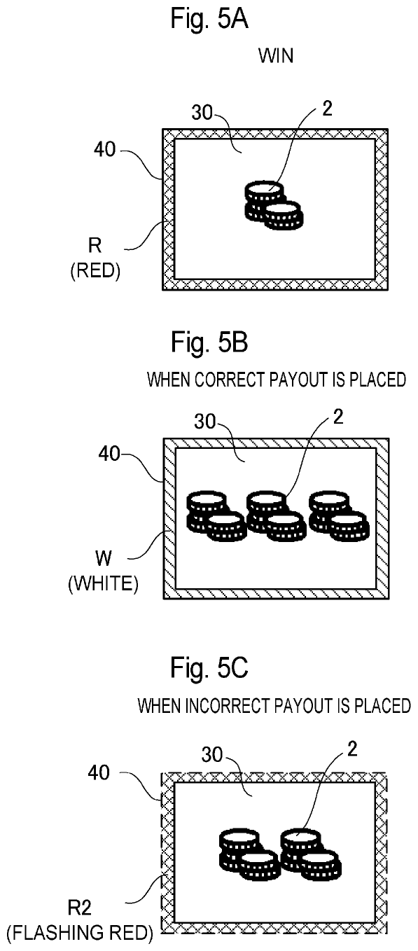

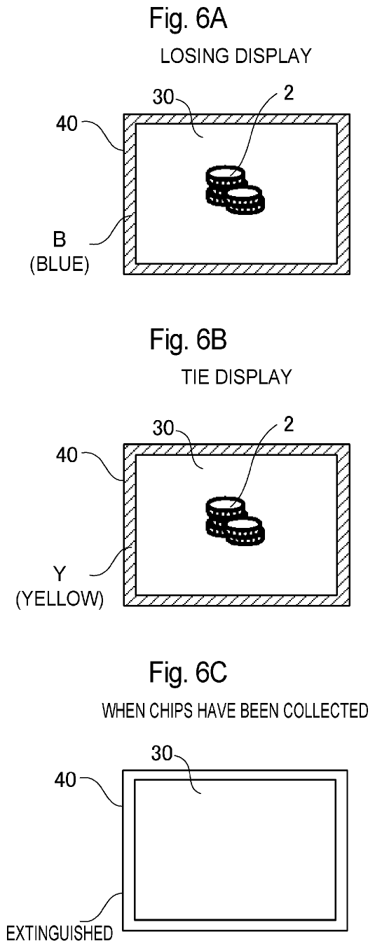

Light emission control: Next, referring to FIGS. 5A, 5B, and 5C, and FIGS. 6A, 6B, and 6C, the light emission control executed on the light emitting unit 40 by the light emission control unit 554 will be described. FIGS. 5A, 5B, and 5C show illustrative views of an example of a winning area display on the game table according to the first embodiment. The light emitting unit 40 of the game table 10 is illuminated on the basis of the game result in order to notify the user and the dealer of the position of the betting area 30 in which the winning bet has been placed. In this embodiment, as shown in FIGS. 5A, 5B, and 5C, for example, when the chips 2 are placed in a “winning” betting area 30 with a payout, or in other words when the user wins the game, the light emission control unit (notification unit) 554 executes illumination processing (notification in a first mode) to cause the light emitting unit 40 to emit light in a first color (red R) as a winning display. Further, when the chips 2 are placed in the winning area during payout, a display indicating whether or not the correct sum has been paid out is performed by varying the light. In this embodiment, as shown in FIG. 5B, for example, when the correct sum is paid out in accordance with the payout rate of the winning area, the light emission control unit 554 executes illumination processing to cause the light emitting unit 40 to emit light in a second color (white W). Further, as shown in FIG. 5C, when an erroneous sum that differs from the payout rate of the winning area is paid out, the light emission control unit 554 executes flashing processing (notification in a second mode) to cause the light emitting unit 40 to flash in the first color (red flashing R2).

FIGS. 6A, 6B, and 6C show illustrative views of an example of a losing area display and a tie display on the game table according to the first embodiment.

As shown in FIG. 6A, when the chips 2 are placed in a “losing” betting area 30 without a payout, or in other words when the user loses the game, the light emission control unit 554 executes illumination processing (notification in a third mode) to cause the light emitting unit 40 to emit light in a third color (blue B). Further, as shown in FIG. 6B, when the game ends in a tie, the light emission control unit 554 executes illumination processing (notification in a fifth mode) to cause the light emitting unit 40 to emit light in a fourth color (yellow Y). Furthermore, when the chips 2 in the “losing” and “tie” areas are collected, the display on the light emitting unit 40 is varied, as shown in FIG. 6C. In this embodiment, for example, when the chips 2 in the “losing” and “tie” areas are collected, the light emitting unit 40 is extinguished (notification in a fourth mode or a sixth mode). In the case of a “tie”, the dealer returns the collected chips 2 to the user.

Actions of game table and payout sum correctness notification method for game table according to first embodiment: Next, referring to FIGS. 1 to 4 and 7, the actions of the game table 10 according to the first embodiment and a payout sum correctness notification method for the game table 10 according to the first embodiment will be described. The payout sum correctness notification method according to the first embodiment is a payout sum correctness notification method for the game table 10, which includes a plurality of betting areas in which chips are placed. The payout sum correctness notification method according to the first embodiment includes a step for reading the placement sum of the chips placed in the betting areas, a step for calculating a payout sum corresponding to the outcome of the game, and a step for controlling light emission by the light emitting unit in accordance with the result of a comparison between the payout sum and the placement sum.

A specific description of an image display method will be provided below. Note that here, processing performed in a case where a bet is placed in the banker area 33 or the player area 34 will be described.

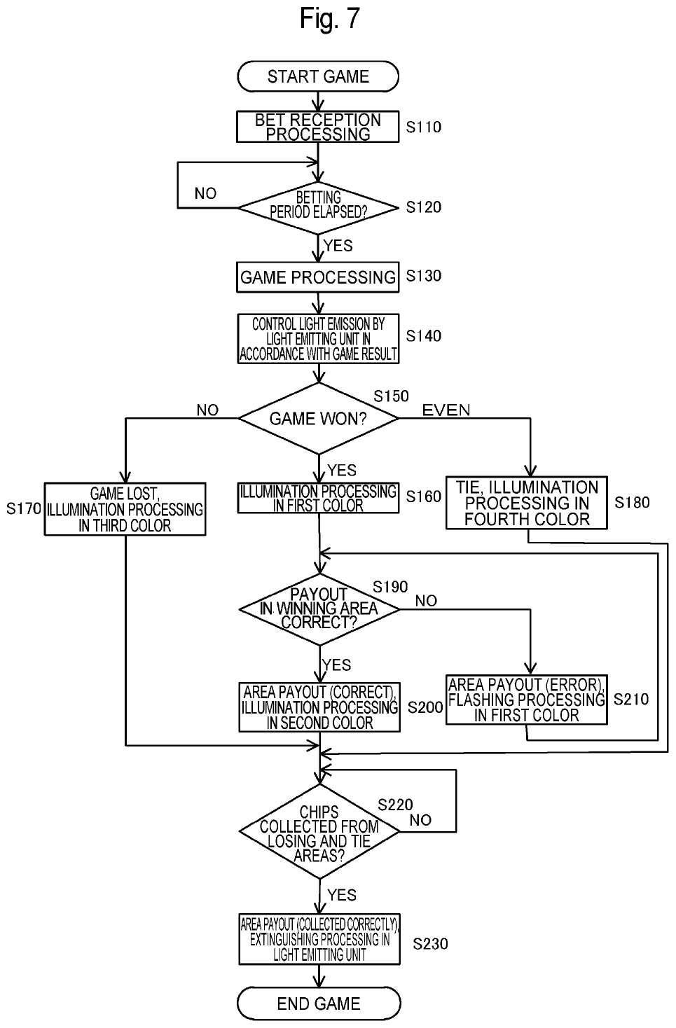

FIG. 7 is a flowchart showing the payout sum correctness notification method for a game table according to the first embodiment. As shown in FIG. 7, when a game is started on the game table 10, first, bet reception processing is started in the betting area 30 of the game table 10 (S110). The start of the bet reception processing is indicated by the dealer and displayed on the display unit 36 of the game table 10, for example. When bet reception starts, the user places a bet. The user places the bet in the betting area 30. More specifically, as shown in FIGS. 2 and 4, the user selects one or a plurality of areas, among the banker pair area 31, the player pair area 32, the banker area 33, the player area 34, and the tie area 35, and bets the chips 2 thereon.

Next, the dealer takes the cards out of the card shoe 25 and places two cards side by side in each of the player area 21 and the banker area 22 of the playing area 20 (see FIGS. 2 and 3).

The management device 550 determines whether or not the betting period has elapsed (S120). When the betting period has elapsed (S120/YES), the dealer and the management device 550 start game processing (S130). When the betting period has not elapsed (S120/NO), the dealer and the management device 550 wait until the betting period has elapsed before starting the game processing. As shown in FIGS. 2 and 3, the dealer executes the game processing by turning over the second card in each of the player area 21 and the banker area 22 one at a time. Note that the user who has bet the largest sum in the betting area 30 may be given the right to narrow down the cards. The management device 550 has a function for specifying the betting area 30 in which the largest placement sum was placed during the betting period and a function for causing the light emitting unit 40 of the specified betting area 30 to emit light, and therefore the user who has the right to narrow down the cards can be specified easily. In accordance with the rules, a third card is dealt to the player area 21 and/or the banker area 22 from the card shoe, whereupon the third card is turned over.

Next, the light emission control unit 554 of the management device 550 executes light emission control on the light emitting unit 40 in accordance with the game result (S140). The management device 550 determines whether or not the user has won the game (S150). When the user has won the game (S150/YES), the light emission control unit 554 executes illumination processing to cause the light emitting unit 40 to emit light in the first color (S160). Further, when the user has lost the game (S150/NO), the light emission control unit 554 executes illumination processing to cause the light emitting unit 40 to emit light in the third color (S170). When the game has ended in a tie (S150/EVEN), the light emission control unit 554 executes illumination processing to cause the light emitting unit 40 to emit light in the fourth color (S180). When the user has placed a bet in the “losing” area or the “tie” area, illumination processing is executed in the third color or the fourth color (S170, S180), whereupon the chips 2 are collected (S220).

When the user has won the game, the payout sum of the “winning” area, calculated by the specification unit 552 of the management device 550, is compared with the placement sum read by the reading device 50 to determine whether or not the payout is correct (S190). More specifically, the management device 550 compares the payout sum, which is calculated from the payout rate of the “winning” area, with the placement sum of the chips 2 placed by the dealer to determine whether or not the payout is correct.

When the payout from the winning area is correct (S190/YES), the light emission control unit 554 executes illumination processing so that the light emitting unit 40 emits light in the second color (S200). When the payout from the winning area is incorrect (S190/NO), the light emission control unit 554 executes flashing processing to cause the light emitting unit 40 to flash in the first color (S210), whereupon the processing returns to S190.

After the light emission control unit 554 executes processing to illuminate the light emitting unit 40 in the second color (S200), the management device 550 determines via the reading device 50 whether or not the chips 2 in the “losing” area have been collected (S220). When the user has not placed a bet in the tie area 35, the determination as to whether or not the chips 2 have been collected (S220) is made even in the event of a “tie”. When the chips 2 in the “losing” and “tie” areas have been collected correctly (S220/YES), the light emission control unit 554 executes processing to extinguish the light emitting unit 40 (S230), whereupon the game is terminated. Until the chips 2 in the “losing” and “tie” areas are collected correctly (S220/NO), the light emission control unit 554 continues to execute the processing to illuminate the light emitting unit 40 in the second color (S200).

As described above, the game table 10 according to the first embodiment includes the reading device 50 for determining the placement sum of the chips 2 placed in the betting area 30, the light emitting unit 40 provided in the betting area 30, and the management device 550 for managing the progress of the game. The management device 550 is a computer device that is caused to execute a function for managing the progress of the game, a function for calculating the payout sum corresponding to the outcome of the game, and a function for controlling light emission by the light emitting unit in accordance with the result of a comparison between the payout sum and the placement sum. Hence, with the game table 10 and the payout sum correctness notification method therefor according to the first embodiment, after the chips 2 are placed in the betting area 30, light emission by the light emitting unit 40 provided on the periphery of the betting area 30 is controlled in accordance with the result of a comparison between the payout sum and the placement sum, and therefore the correctness of the placement sum can be recognized intuitively. Moreover, even in the case of a complicated payout calculation, payout errors and fraud by the dealer can be prevented. Furthermore, likewise for the user, the correctness of the payout of the game is easy to understand, and therefore the user can relax. Note that in a case where a bet is placed in the banker pair area 31, the player pair area 32, or the tie area 35, ties do not occur, but since similar processing to the processing described using FIG. 7 is performed, description thereof has been omitted.

The game table 10 according to the first embodiment also includes a function for causing the light emitting unit 40 to emit light in the first color when the game is won, and a function for causing the light emitting unit to flash when the comparison result is incorrect. Therefore, the fact that the game has been won can be reported in an intuitive manner using the first color, and the fact that an error has occurred in the placement sum of the chips placed as the payout can be reported in an intuitive manner by flashing.

The embodiment described above is used to facilitate understanding of the present invention and is not to be interpreted as limiting the present invention. The respective elements of the embodiment, as well as the arrangements, materials, conditions, shapes, sizes, and so on thereof, are not limited to those described in the embodiment and may be modified as appropriate. Further, configurations illustrated in different embodiments may be partially replaced or combined. For example, the game table 10 according to the first to third embodiments was described using baccarat, which is a traditional card game, as an example, but the present invention may also be applied to a game table for playing other types of games, such as blackjack and roulette.

Further, the monetary value of the bet and the monetary value of the payout may be displayed on the display unit 36, for example. Furthermore, the area in which to place the monetary value of the payout may be provided separately to the betting area 30. In a game such as roulette, in which the betting area is finely divided, the area in which to place the monetary value of the payout is preferably provided separately to the betting area 30.

Further, regarding the display modes of the light emitting unit, display may be performed in various colors and by a combination of extinguishing and flashing processing. Moreover, as well as indicating the state using colors, notifications may be issued using alphabetical character displays, voice, and so on.

### REFERENCE SIGNS LIST

10 Game table
2 Chip
20 Playing area
30 Betting area
40 Light emitting unit
50 Reading device
500 Management system
550 Management device

1. A game table having a plurality of betting areas in which to place chips, the game table comprising:
a reading device that reads a placement sum from information on the chips placed in the betting areas;
a notification unit provided in each of the betting areas; and
a computer device that manages the progress of a game, wherein
the computer device is caused to execute:
a function for managing the progress of the game;
a function for calculating a payout sum corresponding to the outcome of the game; and
a function for executing notification control on the notification unit in accordance with the result of a comparison between the payout sum and the placement sum.

2. The game table according to claim 1, comprising:
a function for causing the notification unit to issue a notification in a first mode when the game is won; and
a function for causing the notification unit to issue a notification in a second mode when there has been an error in the comparison.

3. The game table according to claim 1, comprising:
a function for causing the notification unit to issue a notification in a third mode when the game is lost; and
a function for causing the notification unit to issue a notification in a fourth mode once the placed chips have been collected.

4. The game table according to claim 1, comprising:
a function for causing the notification unit to issue a notification in a fifth mode when the game ends in a tie; and
a function for causing the notification unit to issue a notification in a sixth mode once the placed chips have been collected.

5. The game table according to claim 1, wherein the notification means is a light emitting unit provided in the betting area.

6. The game table according to claim 1, comprising:
a function for specifying the betting area in which the largest placement sum has been placed during a betting period; and
a display function for displaying the specified betting area.

7. The game table according to claim 1, wherein chip identification information is assigned to the chip, and the placement sum is determined by referring to a first database defining a correspondence relationship between the chip identification information and an allocated sum.

8. The game table according to claim 7, wherein area identification information is assigned to the betting area, and the validity of the chips placed in the betting area is determined by referring to a second database defining a correspondence relationship between the chip identification information and the area identification information.

9. A payout sum correctness notification method for a game table having a plurality of betting areas in which to place chips, which comprises the steps of:
reading a placement amount from information on the chips placed in the betting areas;
calculating a payout sum corresponding to the outcome of a game; and
executing notification control on a notification unit provided in each of the betting areas in accordance with the result of a comparison between the payout sum and the placement sum.
